(19) United States
(12) Patent Application Publication
(10) Pub. No.: US 2020/0050957 A1
(43) Pub. Date: Feb. 13, 2020

(54) MODULAR STOCHASTIC MACHINE AND RELATED METHOD

(71) Applicants: CENTRE NATIONAL DE LA RECHERCHE SCIENTIFIQUE, Paris (FR); PROBAYES, Montbonnot-Saint-Martin (FR); THALES, Courbevoie (FR); UNIVERSITE DE PARIS XI PARIS-SUD, Orsay (FR); UNIVERSITE GRENOBLE ALPES, Saint Martin D'hères (FR); SORBONNE UNIVERSITÉ, Paris (FR)

(72) Inventors: Pierre BESSIERE, Paris (FR); Jacques DROULEZ, Paris (FR); Emmanuel MAZER, Biviers (FR); Raphaël LAURENT, Saint Martin D'heres (FR); Julie GROLLIER, Paris (FR); Marvin FAIX, Villard-Bonnot (FR); Alexandre CONINX, Asnieres (FR); David COLLIAUX, Paris (FR); Damien QUERLIOZ, Sceaux (FR)

(21) Appl. No.: 16/340,636

(22) PCT Filed: Oct. 10, 2017
(86) PCT No.: PCT/EP2017/075857

§ 371 Date: Apr. 9, 2019

(30) Foreign Application Priority Data
Oct. 10, 2016 (FR) 16/01463

(51) Int. Cl. G06N 7/00; G06F 17/18; G06F 7/58

(52) U.S. Cl. CPC G06N 7/005; G06F 7/588; G06F 17/18

(57) ABSTRACT

Disclosed is a modular stochastic machine capable of carrying out probability calculations and including: at least one stochastic distribution module corresponding to a plurality of random variables and capable of receiving an input of values of specified variables in order to return, as output, a representation of the distribution of at least one non-specified variable determined by the values of the specified variables; and at least two stochastic variable modules each corresponding to a single random variable and including: both a stochastic multiplier capable of receiving, as input, representations of distributions in order to return, as output, a representation of the product distribution, as well as a stochastic proportional normalizer capable of receiving, as input, a representation of a distribution in order to return, as output, a proportionally normalized representation.

### TECHNICAL FIELD OF THE INVENTION

The present invention relates to a modular stochastic machine. The invention also relates to a corresponding method for calculating probabilities.

### BACKGROUND OF THE INVENTION

A modular stochastic machine is applicable in all fields involving many probability calculations. It for example involves fields relative to the financial markets, economic modeling or weather forecasting.

In particular, a modular stochastic machine makes it possible to solve problems generally solved using the Monte Carlo method with Markov chains.

In the case of finance, for example, the prices of assets are represented as the solution to a stochastic differential equation. The evaluation of products derived from such assets is based, in some cases, on methods for approximating a solution to the stochastic differential equation using a discrete Markov chain combined with the Monte Carlo method.

Currently, in fields using many probability calculations, traditional microprocessors are used, generally within computer systems of the von Neumann type.

In such a case, software instructions are stored in a separate memory of the microprocessor. The latter is able to execute, by reading in the memory, software instructions based on received commands.

The traditional microprocessors have the advantage of being able to execute different operations to solve calculation problems of different natures.

“Traditional microprocessor” refers to a microprocessor handling information presented in a deterministic form, for example using bits corresponding to predefined numeric words, as opposed to a representation in probabilistic form.

However, the traditional microprocessors used in the current computer systems are experiencing a physical limit in terms of computing speed caused by limitations in terms of pacing of the clocks and miniaturization of the components.

Furthermore, so-called stochastic microprocessor structures are known making it possible to eliminate certain constraints set out by the existing deterministic architectures.

However, such structures do not make it possible to perform all of the probability calculations efficiently and flexibly. In particular, the possibility of using a same structure to solve different problems is not addressed at this time. In other words, a structure corresponds to a given particular probability calculation and cannot be used for different calculations.

There is therefore a need to have a stochastic microprocessor structure able to resolve different probability calculation problems, while freeing itself from the technological barriers of a deterministic operation.

### BRIEF DESCRIPTION OF THE INVENTION

To that end, proposed is a modular stochastic machine capable of carrying out probability calculations on stochastic bit streams. The machine comprises at least one stochastic distribution module corresponding to a plurality of random variables, the stochastic distribution module being able to receive an input of values of specified random variables from among the plurality of random variables, and to return as output, a representation of the distribution of probabilities of at least one non-specified random variable conditioned by the values of specified random variables received as input. The machine also comprises at least two stochastic variable modules, each stochastic variable module corresponding to a single random variable. Each stochastic variable module comprises a stochastic multiplier and a stochastic proportional normalizer. A stochastic multiplier is able to receive, as input, representations of a first probability distribution and a second probability distribution of the same random variable, and to return, as output, a representation of the probability distribution produced by said random variable. A stochastic proportional normalizer is able to receive, as input, a representation in bit form of a probability distribution, and to return, as output, a proportionally normalized representation of the received probability distribution, the proportionally normalized representation comprising more bits at 1 than the representation received as input.

According to specific embodiments, the machine comprises one or more of the following features, considered alone or according to any technically possible combinations:

the stochastic distribution module and the stochastic variable modules comprise stochastic bit generators, each stochastic bit generator being able to generate a stochastic bit stream for which the probability of occurrence of bits at 1 is proportional to a value stored in the stochastic bit generator.

the stochastic distribution module comprises as many stochastic bit generators as there are possible combinations of different values of the plurality of random variables.

the representation of the probability distribution returned at the output of the stochastic distribution module is generated from joint or conditional probability values stored in the stochastic distribution module.

a representation of a probability distribution on a random variable is a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank.

the stochastic bit vectors are sample-values, a sample-value comprising only one bit at 1.

each stochastic variable module comprises a stochastic sampler able to be activated and deactivated, a stochastic sampler being able to assume, as input, sample-vectors representing a probability distribution, and to return, as output, sample-values representing the same probability distribution.

each stochastic variable module is suitable for operating according to a regime, called deterministic regime, in which the stochastic variable module is able to deliver a representation of a fixed value of the random variable.

each stochastic variable module is connected to the stochastic distribution module by a data bus, each data bus comprising as many wires as the cardinal of the random variable corresponding to the stochastic variable module.

Also proposed is a probability calculation method to be carried out on at least two random variables. The method comprises the steps of:

providing a modular stochastic machine comprising:
at least one stochastic distribution module corresponding to a plurality of random variables, the stochastic distribution module being able to receive an input of values of specified random variables from among the plurality of random variables, and to return as output, a representation of the distribution of probabilities of at least one non-specified random variable conditioned by the values of specified random variables received as input, and
at least two stochastic variable modules, each stochastic variable module corresponding to a single random variable and comprising:
   a stochastic multiplier able to receive, as input, representations of a first probability distribution and a second probability distribution of the same random variable, and to return, as output, a representation of the probability distribution produced by said random variable, and
   a stochastic proportional normalizer able to receive, as input, a representation in bit form of a probability distribution, and to return, as output, a proportionally normalized representation of the received probability distribution, the proportionally normalized representation comprising more bits at 1 than the representation received as input,
a representation of a probability distribution on a random variable being a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank, the stochastic bit vectors being sample-values, a sample-value comprising only one bit at 1,
each stochastic variable module comprising a stochastic sampler able to be activated and deactivated, a stochastic sampler being able to assume, as input, sample-vectors representing a probability distribution, and to return, as output, sample-values representing the same probability distribution,
each stochastic variable module being suitable for operating according to a regime, called deterministic regime, in which the stochastic variable module is able to deliver a representation of a fixed value of the random variable, and the machine comprising as many stochastic variable modules as there are random variables on which the calculation is done;

activating or deactivating a stochastic sampler of at least one stochastic variable module based on the probability calculation to be done;

optionally configuring a stochastic variable module so that the stochastic variable module operates according to the deterministic regime, and

connecting or disconnecting data buses between certain stochastic variable modules and certain stochastic distribution modules based on the probability calculation to be done.

According to specific embodiments, the calculation method includes one or more of the following features, considered alone or according to any technically possible combinations:

the step for providing a modular stochastic machine comprises a sub-step for determining a number of stochastic distribution modules.

the step for providing a modular stochastic machine comprises a sub-step for determining a number of stochastic variable modules.

the step for providing a modular stochastic machine comprises a sub-step for determining a number of data buses.

the step for providing a modular stochastic machine comprises implementing an algorithm for optimizing the number of stochastic distribution modules, the number of stochastic variable modules, the number of data buses and the arrangement of the stochastic distribution modules, stochastic variable modules and data buses.

### BRIEF DESCRIPTION OF THE DRAWINGS

Other features and advantages of the invention will appear upon reading the following description of embodiments of the invention, solely as an example and done in reference to the drawings, which are:

FIG. 1, a schematic illustration of a set of components making it possible to produce a modular stochastic machine;

FIG. 2, a schematic illustration of an example stochastic distribution module;

FIG. 3, a schematic illustration of an example stochastic variable module;

FIG. 4, a schematic illustration of an example stochastic multiplier;

FIG. 5, a schematic illustration of an example stochastic proportional normalizer;

FIG. 6, a schematic illustration of an example modular stochastic machine; and

FIG. 7, an example configuration of the modular stochastic machine of FIG. 6 to perform a probability calculation.

### DETAILED DESCRIPTION OF THE INVENTION

A modular stochastic machine is an arrangement of different types of components.

The choice of the type of component, the number of components and the arrangement of the components depends on a probability calculation to be done.

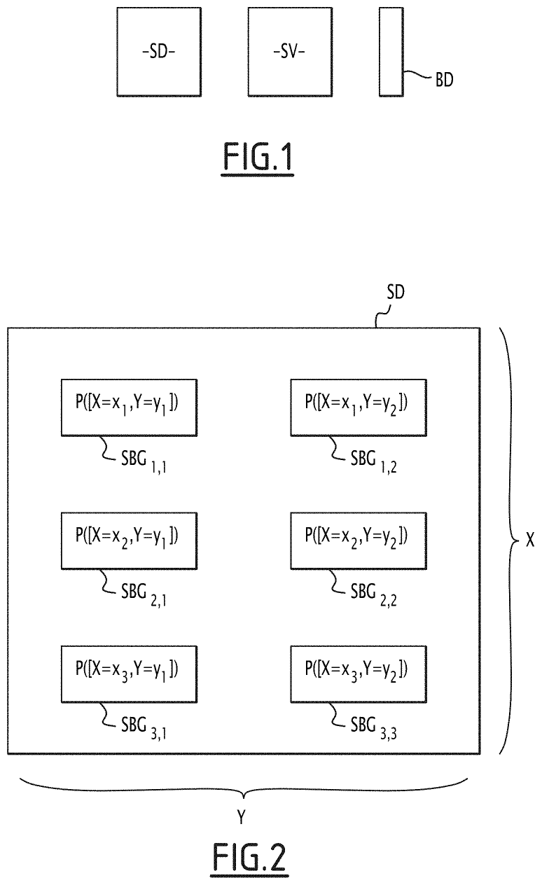

A set of components making it possible to produce a modular stochastic machine is shown in FIG. 1.

As shown in FIG. 1, the set of components comprises three types of components, namely a stochastic distribution module, a random variable module, and a data bus.

Hereinafter, a stochastic distribution module is referred to using the acronym SD, a stochastic variable module is referred to using the acronym SV and a data bus is designated by the acronym BD.

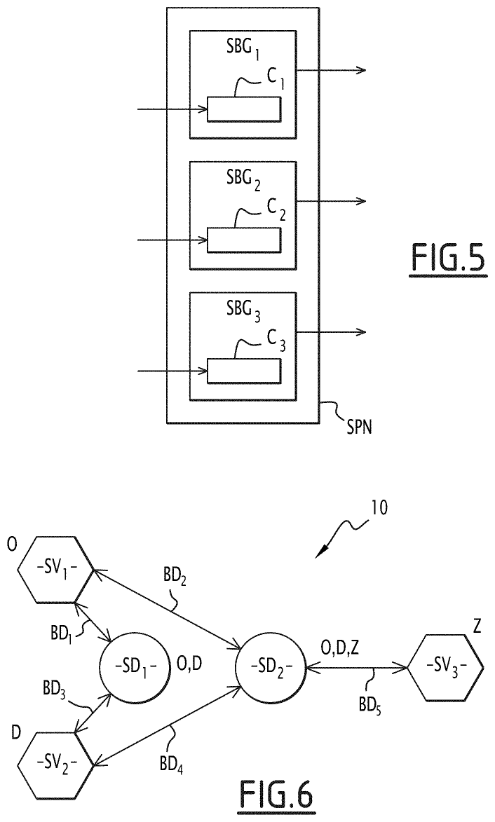

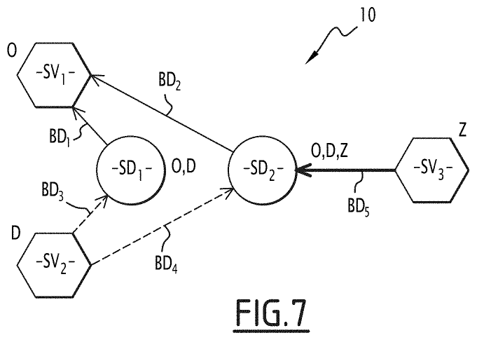

Hereinafter, each component is described independently of one another in reference to FIGS. 2 to 5. Then, an example modular stochastic machine is presented in reference to FIG. 6. Lastly, an example embodiment of the probability calculation method is described in reference to FIG. 7.

Before describing FIGS. 2 to 7, the notations used and general information are presented.

1—Notations

The following notations are used in the present description:
X designates a discrete and finite random variable.
nX designates the cardinal of the random variable X, i.e., the number of possible values assumed by the random variable X.
x₁, x₂, . . . xₙ designates the values assumed by the random variable X.
P(X) designates a probability distribution on the random variable X, i.e., the probability values as a function of the possible values of the random variable X.
P([X=xᵢ]) designates the probability that the random variable X is equal to the value xᵢ.
P(X₁, X₂, Xₙ) designates the joint probability distribution on the random variables X₁, X₂, Xₙ.
P(Xᵢ|Xⱼ) designates the conditional probability of the random variable Xᵢ knowing the random variable Xⱼ.

2—General Information

In deterministic computing, and in particular in traditional microprocessors, information is traditionally represented in the form of bytes, or more generally, in the form of numeric words made up of a fixed number of bits.

Hereinafter, unlike deterministic computing, information is represented in the form of stochastic bit streams.

A “stochastic bit stream” is a set of bits, each bit by definition assuming the value 1 or the value 0. A bit assuming the value 1 is designated by the expression “bit at 1”.

A stochastic bit stream is generated by a stochastic bit generator (SBG).

An SBG is a physical device that comprises a memory intended to store a value, the SGB being able to generate a bit stream whose probability of being at 1 is proportional to the stored value. In other words, a “ratio of bits at 1” of a stochastic bit stream designating the number of bits at 1 divided by the total number of bits in the stream, the ratio of bits at 1 is proportional to the stored value.

An SBG is for example made by using the stochastic properties of magnetic tunnel junctions.

A magnetic tunnel junction is, in its simplest form, a thin insulating barrier, generally not exceeding 1 to 2 nanometers, between two conductive electrodes. The passage of an electric current is done by tunnel effect through this barrier, the tunnel effect designating the property that a quantum object has of crossing a potential barrier even if the energy of the quantum object is lower than the minimum energy required to cross said barrier. At ambient temperature, a super-paramagnetic tunnel effect junction oscillates stochastically between a parallel state and an anti-parallel state. This results in random changes to the resistance of the nano-component that can be used to create stochastic bits.

A probability distribution P(X) on a random variable X is represented by a temporal series of stochastic bit vectors called sample-vectors.

A vector comprises a set of coordinates each corresponding to a rank. Each coordinate is a bit.

Hereinafter, i being an integer, the coordinate with rank i is indifferently designated by the i-th coordinate and indifferently designates the i-th bit or the bit with rank i.

Each sample-vector comprises as many coordinates as there are possible values for the random variable. Formally, for a random variable X of cardinal nX assuming the values x₁, x₂, . . . xₙ, the sample-vectors comprise n coordinates and the coordinate of rank i corresponds to the situation in which the random value X is able to assume the value xᵢ. In particular, the coordinate of rank i is a bit at 1 when the random variable X assumes the value xᵢ.

Furthermore, the ratio of bits at 1 in the temporal series for the coordinates of a same rank relative to the total number of bits is proportional to the probability of the value corresponding to said rank.

Below is a table 1 illustrating an example of 20 sample-vectors representative of the distribution of probabilities P([X=x₁])=0.1; P([X=x₂])=0.5 and P([X=x₃])=0.4:

TABLE 1

| | | | | | | | | | | | | | | | | | | | | |
|---|---|---|---|---|---|---|---|---|---|---|---|---|---|---|---|---|---|---|---|---|
| P([X = x₁]) | 0 | 1 | 0 | 0 | 0 | 1 | 1 | 0 | 0 | 0 | 0 | 0 | 0 | 0 | 0 | 0 | 1 | 0 | 0 | 0 |
| P([X = x₂]) | 1 | 1 | 1 | 1 | 1 | 1 | 1 | 1 | 1 | 1 | 1 | 1 | 1 | 1 | 1 | 1 | 1 | 1 | 1 | 1 |
| P([X = x₃]) | 0 | 1 | 1 | 1 | 1 | 1 | 1 | 1 | 1 | 1 | 1 | 1 | 1 | 0 | 0 | 0 | 1 | 1 | 1 | 1 |

As shown in table 1, the ratio of bits at 1 is 4/20=0.2 for the coordinates of rank 1, 20/20=1 for the coordinates of rank 2 and 16/20=0.8 for the coordinates of rank 3.

The sum of the ratios of bits at 1 being equal to 0.2+1+0.8=2, a normalization by a factor 2 makes it possible to obtain the values of 0.1 for the first line, 0.5 for the second line and 0.4 for the third line.

Alternatively, the vectors of stochastic bits of a temporal series representing a probability distribution P(X) are sample-values.

By definition, a sample-value comprises only one bit at 1.

Below is a table 2 illustrating an example of 20 sample-values representative of the same distribution of probabilities as in the case of the table 1, namely the probability distribution P([X=0])=0.1; P([X=1])=0.5 and P([X=2])=0.4:

TABLE 2

| | | | | | | | | | | | | | | | | | | | | |
|---|---|---|---|---|---|---|---|---|---|---|---|---|---|---|---|---|---|---|---|---|
| P([X = x₁]) | 0 | 1 | 0 | 0 | 0 | 0 | 0 | 0 | 0 | 0 | 0 | 1 | 0 | 0 | 0 | 0 | 0 | 0 | 0 | 0 |
| P([X = x₂]) | 1 | 0 | 0 | 0 | 1 | 0 | 1 | 1 | 0 | 0 | 0 | 0 | 1 | 1 | 1 | 0 | 1 | 0 | 1 | 1 |
| P([X = x₃]) | 0 | 0 | 1 | 1 | 0 | 1 | 0 | 0 | 1 | 1 | 1 | 0 | 0 | 0 | 0 | 1 | 0 | 1 | 0 | 0 |

As shown in table 2, the occurrence ratio of bits at 1 is 2/20=0.1 for the coordinates of rank 1, 10/20=0.5 for the coordinates of rank 2 and 8/20=0.4 for the coordinates of rank 3. Indeed, the ratios of bits at 1 are respectively equal to the values of the represented probability distribution.

A deterministic value, i.e., the particular case where the random variable is known, is represented by a temporal series of sample-values that are all identical where, for each sample-value, the coordinate corresponding to the value of the random variable is a bit at 1, the other coordinates being bits at 0.

For example, as shown by a table 3 below, the random variable X assuming the value X=x₃ is shown by the following temporal series of sample-values:

TABLE 3

| | | | | | | | | | | | | | | | | | | | | |
|---|---|---|---|---|---|---|---|---|---|---|---|---|---|---|---|---|---|---|---|---|
| P([X = x₁]) | 0 | 0 | 0 | 0 | 0 | 0 | 0 | 0 | 0 | 0 | 0 | 0 | 0 | 0 | 0 | 0 | 0 | 0 | 0 | 0 |
| P([X = x₂]) | 0 | 0 | 0 | 0 | 0 | 0 | 0 | 0 | 0 | 0 | 0 | 0 | 0 | 0 | 0 | 0 | 0 | 0 | 0 | 0 |
| P([X = x₃]) | 1 | 1 | 1 | 1 | 1 | 1 | 1 | 1 | 1 | 1 | 1 | 1 | 1 | 1 | 1 | 1 | 1 | 1 | 1 | 1 |

Alternatively, the sample-values are replaced by bits encoding given information, like in traditional deterministic computing.

The components of the set of components shown in FIG. 1 making it possible to produce a modular stochastic machine are now described.

3—The SD module

3.1—Structure of a SD module

A SD module corresponds to a plurality of random variables.

“Plurality of random variables” refers to at least two random variables.

A SD module for example corresponds to two random variables.

A SD module for example corresponds to at least twenty random variables.

A SD module is able to receive an input of values of specified random variables from among the plurality of random variables, and to return as output, a representation of the distribution of probabilities of at least one non-specified random variable conditioned by the values of specified random variables received as input.

In other words, a SD module corresponding to the random variables X₁, X₂, Xₙ is able to return, as output, for example, a representation of the following probability distribution:

P(Xₙ|x₁, x₂, xₙ₋₁)

where x₁, x₂, . . . xₙ₋₁corresponding to the values respectively assumed by the specified random variables X₁, X₂, . . . Xₙ₋₁.

In embodiments, a SD module is for example able to receive, as input, n−1 sample-values respectively representing the values x₁, x₂, . . . xₙ₋₁of specified random variables X₁, X₂, . . . Xₙ₋₁ and is able to return, as output, sample-values of the distribution of probabilities P(Xₙ|x₁, x₂, . . . xₙ₋₁).

Furthermore, a SD module comprises a plurality of SBGs.

In particular, the SD module comprises as many SBGs as there are possible combinations of different values of the plurality of random variables.

For example, a SD module corresponding to two random variables X, Y each assuming two values (x,x′) and (y,y′) comprises four SBGs, since there are four possible combinations, which are (x,y), (x,y′), (x′,y) and (x′,y′).

The representation of the probability distribution returned at the output of the SD module is generated from joint or conditional probability values stored in the SD module.

In particular, each SBG is able to store, in the memory of the SBG, a joint probability value over several random variables to generate a stream of stochastic bits representative of the stored value.

A SD module also comprises a control system able to activate the outputs of the SBG corresponding to specified random variable values.

As an illustration, the reception as input of a sample-value representing the information Yᵢ=yᵢ, the control system is able to select the outputs of the SBG corresponding to probability values in particular knowing that the random variable Yᵢ is set at the value yᵢ. In this case, the outputs of the SBGs corresponding to the probability values knowing that the random value Yᵢ is set at different values y_{j≠i} are deactivated and the corresponding SBGs then do not generate stochastic bit streams.

Advantageously, when a SBG is deactivated, it is able to generate only bits at 1. This has the advantage of generating a stream of “transparent” stochastic bits, in particular when such a stream of stochastic bits is found at the input of an AND logic gate.

3.2—Operation of a SD module

The operation of a SD module is described in reference to an example SD module shown in FIG. 2.

The SD module of FIG. 2 corresponds to two random variables X and Y and is able to store the probability distribution P(X, Y).

In this case, the SD module comprises nX×nY SBGs. nX being equal to 3 and nY being equal to 2, the SD module comprises six SBGs.

The SBGs are denoted SBG_{i,j,}, i being an integer varying from 1 to 3, j being an integer varying from 1 to 2. SBG_{i,j} is able to generate a stochastic bit stream representative of the probability value P([X=xᵢ, Y=yⱼ]).

In the present example, the probability of the random variable X assuming the value x₁ and the random variable Y assuming the value y₁ being equal to 0.2, the SBG_{1,2} is able to generate, once the output of the SBG_{1,2} has been activated by the control system of the SBG_{1,2}, a stochastic bit stream representative of the value 0.2.

The SD module of FIG. 2 also makes it possible to generate a representation in the form of a temporal series of sample-values of the conditional probability distribution P([X|Y=y₁]).

The SD module of FIG. 2 for example makes it possible to generate a representation in the form of a temporal series of sample-values of the joint probability distribution P([X, Y=y₁]).

To generate a representation in the form of a temporal series of sample-values of the conditional probability distribution P([X|Y=y₁]), the SD module receives, as input, the following sample-value representative of the information Y=y₁:

| | |
|---|---|
| P([Y = y₁]) | 1 |
| P([Y = y₂]) | 0 |

Upon receiving the above sample-value, the control system activates the inputs of the SBG_{1,1}, SBG_{2,1} and SBG_{3,1} respectively corresponding to the probability values P([X=x₁, Y=y₁]), P([X=x₂, Y=y₁]) and P([X=x₃, Y=y₁]).

The SBG_{1,1}, SBG_{2,1} and SBG_{3,1} are, in this case, able to generate a temporal series of stochastic bit vectors whereof the rank 1 coordinates are formed by the stochastic bit stream generated by the SGB_{1,1}, the rank 2 coordinates are formed by the stochastic bit stream generated by the SGB_{2,1} and the rank 3 coordinates are formed by the stochastic bit stream generated by the SBG_{3,1}.

The temporal series of sample-vectors generated by the combination of SBG_{1,1}, SBG_{2,1} and SBG_{3,1} then represents the desired probability distribution P([X, Y=y₁]).

4—The SV Module

4.1—Structure of a SV Module

A SV module corresponds to a single random variable.

In particular, each SV module corresponds to a random variable chosen from among the plurality of random variables corresponding to a SD module.

Each SV module is able to be connected to at least one SD module by a data bus able to transmit stochastic bits. The SD data buses are described in more detail hereinafter.

In certain embodiments, an SV module is only connected to the SD module(s) corresponding to a plurality of random variables, the plurality of random variables containing the random variable corresponding to the SV module.

An SV module comprises a stochastic product operator (SPO), and a stochastic proportional normalizer (SPN).

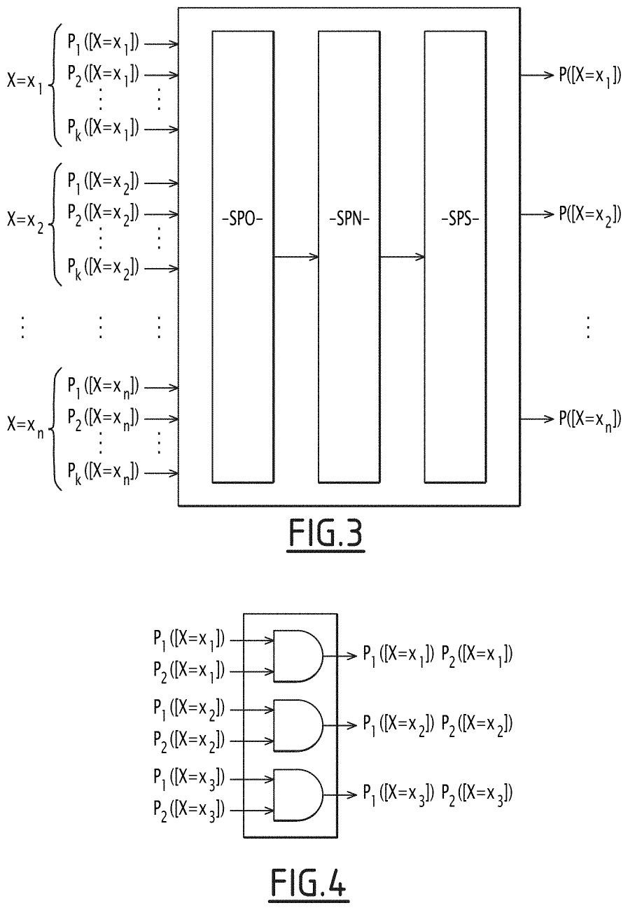

In certain embodiments, as shown in FIG. 3, an SV module also comprises a stochastic proportional sampler (SPS).

As shown in FIG. 3, an SV module corresponding to the random variable X assuming the values x₁, x₂, . . . , xₙ is able to receive, as input, sample-vectors representative of a plurality of different probability distributions P₁(X), P₂(X), . . . , Pₖ(X) of the random variable X to generate, as output, a representation in the form of a proportionally normalized temporal series of sample-vectors of a probability distribution P(X) of said random variable X.

When an SV module comprises an activated SPS, the SV module is capable of generating, as output, a representation in the form of a proportionally normalized temporal series of sample-values of a probability distribution P(X) of said random variable X. In such a case, it is stated that the SV module is able to return a temporal series of samples representative of sampled values of the random variable corresponding to said SV module.

In particular, the representation of the probability distribution generated as output of the SV module is the proportionally normalized representation of the probability distribution produced from the probability distributions received as input.

Furthermore, the SV module is suitable for operating according to a regime, called deterministic regime, in which the SV module delivers stochastic bit streams representative of a value set for a random variable.

For example, if the random variable X with cardinal nX=3 is set at the value X=x₂, the random variable is said to be deterministic and the SV module is configured to operate in the deterministic regime. In such a case, the SV module returns the following sample-values as output:

| | | | | | | | | | | | | | | | | | | | | |
|---|---|---|---|---|---|---|---|---|---|---|---|---|---|---|---|---|---|---|---|---|
| P([X = x₁]) | 0 | 0 | 0 | 0 | 0 | 0 | 0 | 0 | 0 | 0 | 0 | 0 | 0 | 0 | 0 | 0 | 0 | 0 | 0 | . . . |
| P([X = x₂]) | 1 | 1 | 1 | 1 | 1 | 1 | 1 | 1 | 1 | 1 | 1 | 1 | 1 | 1 | 1 | 1 | 1 | 1 | 1 | . . . |
| P([X = x₃]) | 0 | 0 | 0 | 0 | 0 | 0 | 0 | 0 | 0 | 0 | 0 | 0 | 0 | 0 | 0 | 0 | 0 | 0 | 0 | . . . |

The components forming an SV module are now described.

To facilitate the understanding, hereinafter it is considered that the SV module is on the one hand able to receive first and second probability distributions on the random variable X that are respectively denoted P₁(X) and P₂(X), and on the other hand able to generate the produced probability distribution denoted P(X) of the probability distributions P₁(X) and P₂(X).

One skilled in the art will understand that the following applies similarly to the case where the SV module receives more than two probability distributions. For example, in the case where an SV module receives three probability distributions, the SV module is for example a cascading arrangement of two SV modules as described below.

The components forming an SV module are now described independently of one another.

4.1.1—Description of an SPO

An example SPO is shown in FIG. 4.

The SPO is able to receive, as input, representations in the form of sample-vectors respectively of the first probability distribution P₁(X) and the second probability distribution P₂(X) in order to return, as output, a representation of the produced probability distribution of the same random value X.

The SPO comprises AND logic gates each corresponding to one possible value of the random variable X.

An AND logic gate is a component implementing the “AND” function. The “AND” function is a logic operator in Boolean algebra that uses, as input, two operands assuming the TRUE value or the FALSE value and that returns the TRUE value if and only if both operands have the TRUE value. A logic gate is for example an electronic component comprising, as input, two terminals supplied either by a nil voltage, or by a voltage equal to 5 V and which comprises an output having a nil voltage or a voltage equal to 5 V. The voltage value of 5 V corresponds to the TRUE value, i.e., a bit at 1, and the nil voltage value corresponds to the FALSE value, i.e., a bit at 0. In this case, the output voltage is equal to 5 V if and only if the input voltages are both equal to 5 V.

As shown in FIG. 4, the SPO comprises three AND gates denoted AND₁, AND₂, and AND₃. I being an integer varying from 1 to 3, the gate ANDᵢ corresponding to the value xᵢ of the random variable X.

For the index i varying from 1 to 3, the gate ANDᵢ receives the first stochastic bit stream representative of the value P₁(X=xᵢ) and a second stochastic bit stream representative of the value P₂(X=xᵢ).

The ANDᵢ gate obtains, one by one, the product of the bits of each of the received streams in order to return, as output, a stochastic bit stream representative of the value P₁(X=xᵢ)P₂(X=xᵢ).

In fact, as shown in FIG. 4, the SPO is able to generate a temporal series of sample-vectors that is represented in the form:

| | |
|---|---|
| X = x₁ | P₁(X = x₁)P₂(X = x₁) |
| X = x₂ | P₁(X = x₂)P₂(X = x₂) |
| X = x₃ | P₁(X = x₃)P₂(X = x₃) |

It emerges from the various probability products P₁(X=xᵢ)P₂(X=xᵢ) that the sample-vectors at the output of the SPO necessarily comprise fewer bits at 1 than the sample-vectors respectively representing the probability distributions P₁(X) and P₂(X).

This phenomenon, called temporal dilution, can cause slowing of the calculations, since the time needed to evaluate the ratios of bits at 1 to a stochastic bit stream increases. In other words, the evaluation of the likelihood of occurrence of bits at 1 requires increasingly long stochastic bit streams.

4.1.2—Description of an SPN

An SPN is able to receive, as input, a representation in bit form of a probability distribution P(X), and to return, as output, a proportionally normalized representation of the received probability distribution, the proportionally normalized representation comprising more bits at 1 than the representation received as input.

In particular, the coordinate of rank i of the sample-vectors of the proportionally normalized representation has a likelihood of being at 1 proportional to the value of the probability P([X=xᵢ]).

The addition of bits at 1 is done proportionally, i.e., the relationships between the ratios of bits at 1 for different ranks of the sample-vectors are unchanged.

An SPN is in particular adapted to offset the issue of temporal dilution.

In the case of an SV module, the output of the SPO is connected to the input of the SPN and the sample-vectors received as input of the SPN are the sample-vectors returned at the output of the SPO.

An example SPN is shown in FIG. 5.

According to the example of FIG. 5, the illustrated SPN is able to generate sample-vectors representative of the probability distribution P(X) whose coordinates corresponding to the maximum probability of the probability distribution P(X) are all bits at 1.

FIG. 5 illustrates the specific case of a random variable X assuming three values x₁, x₂, x₃ and a probability distribution P(X) on the random variable X defined as follows:

P([X=x₁])=0.1

P([X=x₂])=0.1

P([X=x₃])=0.8

The SPN comprises three SBGs denoted SBG₁, SBG₂ and SBG₃ respectively corresponding to the values X=x₁, X=x₂ and X=x₃.

Each SBG corresponding to a value of the random variable X receives a stochastic bit stream corresponding to the coordinates, in the received sample-values, corresponding to this same value of the random variable X.

For i varying from 1 to 3, the SBGⱼ receives the coordinates of rank i of the sample-vectors representative of the probability distribution P(X), i.e., the coordinates corresponding to the case where X=xᵢ.

Furthermore, each SBG₁, SBG₂ and SBG₃ comprises a counter respectively denoted C₁, C₂ and C₃.

The counters C₁, C₂ and C₃ all have the same capacity, denoted Nₘₐₓ.

Each counter C₁, C₂ and C₃ is able to be incremented upon receiving a bit at 1. For i an integer varying from 1 to 3, the number of incrementations of a counter Cᵢ is denoted Nᵢ and is called the content of the counter Cᵢ.

The counter Cᵢ is said to be full when Nᵢ=Nₘₐₓ.

In the example of FIG. 5, the SPN receiving sample-vectors representative of the probability distribution P(X), the counters C₁, C₂ and C₃ are incremented until a counter is full.

Once a counter is full, the SPN is able to stop the incrementation of the other counters.

In the present example, the maximum probability of the probability distribution P(X) corresponds to the case where X=x₃. In fact, the counter C₃ of the SBG₃ corresponding to the case where X=x₃ is the counter that is the first to be filled.

The SPN having stopped the incrementation of the other counters, each SBGᵢ generates stochastic bit streams with for probability of having a bit equal to 1 equal to the content Nᵢ of the counter Cᵢ divided by the capacity Nₘₐₓ of the counters.

In the present example, it is considered that the capacity Nₘₐₓ of the counters is equal to 200.

The SPN stops the incrementation of the other counters when, for example, the contents of the counters are as follows:

N₁=25

N₂=25

N₃=200=Nₘₐₓ

The ratios of bits at 1 of the first, second and third coordinates are respectively equal to:

25/200=0.125

25/200=0.125

200/200=0.125

By normalizing by the value 0.125+0.125+1=1.25, one obtains:

P([X=x₁])=0.125/1.25=0.1

P([X=x₂])=0.125/1.25=0.1

P([X=x₃])=1/1.25=0.8

As shown in this example, the sample-vectors at the output of the SPN representative of the probability distribution P(X) comprise more bits at 1 than the sample-vectors at the input of the SPN representative of the same probability distribution P(X). The addition of bits at 1 therefore has the advantage of reducing the temporal distribution.

According to other variants, the SPN also comprises counters that, unlike the example previously described, are able to be decremented when their capacity is reached and the bit to be generated is at 1.

4.1.3—Description of an SPS

An SPS is able to receive sample-vectors forming a proportionally normalized representation of a distribution of probabilities to return, as output, sample-values representing the same probability distribution.

In the case of an SV module, the SPS is connected as input to the output of the SPN to receive sample-vectors forming a proportionally normalized representation of the probability distribution P(X) and to return, as output, sample-values representing the same probability distribution P(X).

Furthermore, the SPS is able to be activated and deactivated.

When the SPS is deactivated, the SPS behaves like a passive component. In such a case, the output of the SV module corresponds to the output of the SPN and the SV module returns proportionally normalized sample-vectors representative of the produced probability distribution of the representations of the probability distributions received at the input of the SV module.

When the SPS is activated, the SPS performs a “conversion” of the sample-vectors received at the input to return sample-values. In such a case, the SPS delivers sample-values representative of sampled values of the random variable corresponding to the SV module.

Indeed, when the SPS is activated, the SV module returns, as output, sample-values comprising a single bit at 1 and for which the probability that the coefficients of rank i are bits at 1 is proportional to the probability that the random variable corresponding to the SV module assumes the value xᵢ.

4.2—Operation of an SV Module

An SV module being the arrangement of an SPO, an SPN and an SPS, the operation of an SV module results from the respective operations of an SPO, an SPN and an SPS previously described.

It is considered hereinafter that the SV module does not work in a deterministic regime.

The SV module receives, as input, a set of sample-vectors representative of a plurality of different probability distributions of a same random variable.

The input of the SV module being combined with the input of an SPO, the SPO returns, as output, sample-vectors representative of the produced probability distribution of the different probability distributions received as input.

The output of the SPO being connected to the input of an SPN, the SPN receives, as input, the sample-vectors generated by the SPO and which are representative of the produced probability distribution of the different probability distributions received as input of the SV module. The SPO then performs a normalization of the representation received in sample-vector form, the normalization consisting of adding bits at 1 while keeping the relationships between the ratios of bits at 1 identical to the relationships between the ratios of bits at 1 of the representation provided at the input of the SV module.

The action of the SPN results in reducing the temporal dilution caused by the SPO.

Lastly, the output of the SPN being connected to the input of the SPS, the SPS receives, as input, the proportionally normalized sample-vectors representative of the produced probability distribution of the different probability distributions received at the input of the SV module.

Two cases then arise.

In a first case, the SPS is deactivated and the SPS behaves like a passive component. In this first case, the output of the SV module corresponds to the output of the SPN. In other words, the SV module returns, as output, proportionally normalized sample-vectors representative of the produced probability distribution of the different probability distributions received as input of the SV module.

In a second case, the SPS is activated and the SPS then converts the sample-vectors received at the input into sample-values. In such a case, the output of the SV module corresponds to the output of the SPS and the SV module returns, as output, sample-values representative of sampled values of the random variable corresponding to the SV module.

It is now considered that the SV module works in a deterministic regime.

In such a case, a value for the random variable corresponding to the SV module is set and the SV module returns, as output, sample-values representative of the value of the random variable.

5—The Data Buses

The data buses BD are able to connect SD modules and SV modules to one another.

In embodiments, each data bus BD comprises as many wires as the cardinal of the random variable corresponding to the SV module.

For example, an SV module corresponding to the random variable X is connected to an SD module corresponding to the random variables X, Y by a data bus comprising nX wires.

In other embodiments, the data buses BD are all identical and in fact each comprise the same number of wires.

The data buses are able to be connected or disconnected. In other words, each data bus is able to be activated or inhibited so that no stochastic bit is transmitted.

A connection or a disconnection of a data bus for example results from the activation of a function integrated into an SD module or an SV module.

The data buses are formed by any type of physical medium able to convey binary information. As an illustration, the data buses are wires, printings on a circuit, or devices suitable for exchanging electromagnetic waves or optical signals.

6—The Modular Stochastic Machine

6.1—Structure of a Modular Stochastic Machine

A modular stochastic machine is capable of carrying out probability calculations on stochastic bit streams from at least two random variables.

The modular stochastic machine comprises SBGs, at least one SD module, at least two SV modules and data buses BD able to connect SD modules and SV modules to one another.

The stochastic machine is described as modular because the stochastic machine is an assembly of SD modules, SV modules and data buses BD.

The assembly of a modular stochastic machine depends on probability calculations to be done. In other words, a given assembly corresponds to a set of probability calculations and a particular configuration of the assembly is able to perform a particular probability calculation from among the set of probability calculations.

An example modular stochastic machine 10 is shown in FIG. 6.

In this example, the machine 10 comprises three SV modules and two SD modules.

A first SV module is denoted SV₁, a second SV module is denoted SV₂ and a third SV module is denoted SV₃.

The first module SV₁ corresponds to a random variable O, the second module SV₂ corresponds to a random variable D and the third module SV₃ corresponds to a random variable Z.

A first SD module is denoted SD₁ and a second SD module is denoted SD₂.

The first module SD₁ corresponds to the random variables O, D and the second module SD₂ corresponds to the random variables O, D, Z.

As shown in FIG. 6, the machine 10 comprises a first data bus BD₁, a second data bus BD₂, a third data bus BD₃, a fourth data bus BD₄ and a fifth data bus BD₅.

The first data bus BD₁ connects the first module SV₁ to the first module SD₁.

The second data bus BD₂ connects the first module SV₁ to the second module SD₂.

The third data bus BD₃ connects the second module SV₂ to the first module SD₁.

The fourth data bus BD₄ connects the second module SV₂ to the second module SD₂.

The fifth data bus BD₅ connects the third module SV₃ to the second module SD₂.

The operation of the machine 10 will now be described.

6.2—Operation of a Modular Stochastic Machine

An example implementation of a probability calculation method using a modular stochastic machine is now described, in reference to FIG. 7.

FIG. 7 corresponds to FIG. 6, in which the data buses BD₁, BD₂, BD₃, BD₄ and BD₅ are shown differently in order to illustrate an example calculation from the machine 10 of FIG. 6.

The following conventions relative to the data buses are used hereinafter:

the direction of an arrow indicates the transmission direction of the stochastic bit streams;

an arrow shown in dotted lines depicts the transmission of sample-values representative of sampling by the random value corresponding to the SV module from which the arrow is derived;

an arrow shown in thick lines depicts the transmission of sample-values, all identical, representative of the value set for a random variable, and

an arrow shown in thin lines depicts the transmission of sample-vectors representative of a probability distribution.

In the example of FIG. 7, the random variables O, D, Z describe an automatic driving assistance system for motor vehicles.

The space in front of the vehicle is shown by a probabilistic occupancy grid made up of different cells in which, for each cell, sensors are installed to calculate probabilities.

The random variable O is binary and is equal to 1 if the cell is occupied.

The random variable D is binary and is equal to 1 if there has been a detection by the sensor.

The random variable Z is a numerical random value that corresponds to the value provided by a sensor.

In the present example, the problem to be solved is the following: what is the probability that a cell is occupied, knowing the measurement from the sensor?

Formulated in mathematical terms, the problem amounts to determining the probability distribution on the random variable modeling the occupancy knowing the value returned by the sensor, i.e., the probability distribution P(O|Z=z).

It is considered that the probability distributions P(O, D), P(O, D, Z) are known, for example using tests.

By construction, the probability distribution P(O, D) indicates the probabilities corresponding to:

good detections, it involves cases in which {O=1, D=1} or {O=0, D=0};

false detections, it involves cases in which {O=0, D=1}, and

missed targets, it involves cases in which {O=1, D=0}.

By construction, the probability distribution P(O, D, Z) describes the operation of the sensor in the cases of good detections, false detections and missed targets.

In a known manner, the desired probability distribution is expressed as follows:

P(O|Z=z)=Σ_{D}P(O, D)P(O, D, Z=z)

The above probability calculation is done using a modular stochastic machine according to the probability calculation method.

The method comprises a step for providing a modular stochastic machine.

The provision step comprises sub-steps.

In a first sub-step, the number of SV modules is determined. The calculation to be done involving three random variables O, D, Z, three SV modules respectively corresponding to the three random variables O, D, Z are provided.

Then, in a second sub-step, the number of SD modules is determined. The probability distributions P(O, D), P(O, D, Z) being known, two SD modules respectively corresponding to the random variables O, D and O, D, Z are provided.

Lastly, in a third sub-step, the number of data buses BD is determined. The third sub-step is implemented based on the rule according to which an SV module is only connected to the SD module(s) corresponding to a plurality of random variables, the plurality of random variables containing the random variable corresponding to the SV module. In the present case, five data buses BD are necessary.

At the end of the provision step, the modular stochastic machine 10 of FIG. 6 is obtained.

In specific embodiments, the provision step comprises implementing an algorithm for optimizing the number of SD modules, the number of SV modules, the number of data buses and the arrangement of the SD modules, SV modules and data buses.

In specific embodiments, the provision step is carried out automatically by a software method consisting of running through the structure of the breakdown of the desired probability distribution to produce an optimal arrangement of SD modules, SV modules and data buses BD.

Then, a first set of steps is carried out.

The first set of steps comprises sub-steps for activating or deactivating a SPS of at least one SV module based on the probability calculation to be done.

In the present example, the SPS of the second module SV₂ is activated. In this case, the second module SV₂ delivers sample-values representative of sampled values of the random variable D that are transmitted to the first module SD₁ on the one hand and to the second module SD₂ on the other hand, since the first and second modules SD₁ and SD₂ each correspond to the random variable D.

The third and fourth data buses BD₃, BD₄ connecting the second module SV₂ to the first module SD₁ and to the second module SD₂ on the other hand are then shown by dotted arrows.

Furthermore, the first set of steps comprises sub-steps consisting of operating SV modules according to the deterministic regime.

In the present example, the third module SV₃ is configured to operate according to the deterministic regime. In this case, the third module SV₃ delivers sample-values that are all identical and that are representative of the value z set for the random variable Z that are transmitted to the second module SD₂, since only the second module SD₂ corresponds to the random variable Z.

The fifth data bus BD₅ connecting the third module SV₃ to the second module SD₂ is then shown by an arrow in thick lines.

From this configuration of the modular stochastic machine, the first module SD₁ receives, from the second module SV₂, sampled values of the random variable D that is specified.

The module SD, then generates a representation in the form of sample-values of a first probability distribution P₁(O) that is expressed as follows:

P(O)=P(O|D=d)

where the values d assumed by the random variable D correspond to the sample-values representative of the sampled values of the random variable D returned at the output of the second module SV₂.

This operation is possible due to the reception of sample-values representative of sampled values of the random variable D.

The sample-vectors representative of the first probability distribution P₁(O) are transmitted to the first module SV₁ by the first data bus BD₁, represented by an arrow in thin lines.

In parallel, the second module SD₂ receives, from the third module SV₃, identical sample-values representative of the set value z for the random variable Z and also receives, from the second module SV₂, sample-values representative of sampled values of the random variable D that is specified.

The module SD₂ then generates a representation in the form of sample-vectors of a second probability distribution P₂(O) that is expressed as follows:

P₂(O)=P(O|D=d, Z=z)

where the values d assumed by the random variable D correspond to the sample-values representative of the sampled values of the random variable D returned at the output of the second module SV₃, and where the value z assumed by the random variable Z corresponds to the identical sample-values representative to the set value z for the random variable Z returned as output of the third module SV₃.

This operation is possible due to the reception of sample-values representative of sampled values of the random variable D and sample-values representative of the value z set for the random variable Z.

The sample-vectors of the second probability distribution P₂(O) are sent to the first module SV₁ by the second data bus BD₂, depicted by an arrow in thin lines.

The first module SV₁ then performs the following operation:

P(O|Z=z)=Σ_{D}P(O|D=d)P(O|D=d, Z=z)=Σ_{D}P₁(O)P₂(O)

In other words, the first module SV₁ returns, as output, a proportionally normalized representation of the product of the probability distributions P₁(O) and P₂(O) and in fact provides the result to the posed problem.

The modular stochastic machine 10 is configurable in various ways in order, for example, to calculate the probability distributions P(Z|O=o, D=d) or P(Z|D=d).

A modular stochastic machine thus offers the possibility of performing a wide variety of probability calculations.

Furthermore, the use of a modular stochastic machine is particularly simple and does not require many operations.

The calculation speed is considerably increased relative to traditional microprocessors.

1. A modular stochastic machine (10) capable of carrying out probability calculations on stochastic bit streams, the machine comprising:
at least one stochastic distribution module (SD) corresponding to a plurality of random variables (O, D, Z), the stochastic distribution module (SD) being able to receive an input of values of specified random variables from among the plurality of random variables, and to return as output, a representation of the distribution of probabilities of at least one non-specified random variable conditioned by the values of specified random variables received as input, and
at least two stochastic variable modules (SV), each stochastic variable module (SV) corresponding to a single random variable (O, D, Z) and comprising:
a stochastic multiplier (SPO) able to receive, as input, representations of a first probability distribution (P₁(X)) and a second probability distribution (P₂(X)) of a same random variable (X), and to return, as output, a representation of the produced probability distribution (P(X)) of said random variable (X), and
a stochastic proportional normalizer (SPN) able to receive, as input, a representation in bit form of a probability distribution, and to return, as output, a proportionally normalized representation of the received probability distribution, the proportionally normalized representation comprising more bits at 1 than the representation received as input.

2. The machine (10) according to claim 1, wherein the stochastic distribution module (SD) and the stochastic variable modules (SV) comprise stochastic bit generators (SBG), each stochastic bit generator (SBG) being able to generate a stochastic bit stream for which the probability of occurrence of bits at 1 is proportional to a value stored in the stochastic bit generator (SBG).

3. The machine (10) according to claim 2, wherein the stochastic distribution module (SD) comprises as many stochastic bit generators as there are possible combinations of different values of the plurality of random variables.

4. The machine (10) according to claim 1, wherein the representation of the probability distribution returned at the output of the stochastic distribution module (SD) is generated from joint or conditional probability values stored in the stochastic distribution module (SD).

5. The machine (10) according to claim 1, wherein a representation of a probability distribution on a random variable is a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank.

6. The machine (10) according to claim 5, wherein the stochastic bit vectors are sample-values, a sample-value comprising only one bit at 1.

7. The machine (10) according to claim 1, wherein each stochastic variable module (SV) comprises a stochastic sampler (SPS) able to be activated and deactivated, a stochastic sampler (SPS) being able to assume, as input, sample-vectors representing a probability distribution, and to return, as output, sample-values representing the same probability distribution.

8. The machine (10) according to claim 7, wherein each stochastic variable module (SV) is suitable for operating according to a regime, called deterministic regime, in which the stochastic variable module (SV) is able to deliver a representation of a fixed value of the random variable.

9. The machine (10) according to any one of claim 8, wherein each stochastic variable module (SV) is connected to the stochastic distribution module (SD) by a data bus, each data bus comprising as many wires as the cardinal of the random variable corresponding to the stochastic variable module (SV).

10. A probability calculation method to be carried out on at least two random variables, the method comprising the steps of:
providing a modular stochastic machine (10 ) comprising:
at least one stochastic distribution module (SD) corresponding to a plurality of random variables (O, D, Z), the stochastic distribution module (SD) being able to receive an input of values of specified random variables from among the plurality of random variables, and to return as output, a representation of the distribution of probabilities of at least one non-specified random variable conditioned by the values of specified random variables received as input, and
at least two stochastic variable modules (SV), each stochastic variable module (SV) corresponding to a single random variable (O, D, Z) and comprising:
a stochastic multiplier (SPO) able to receive, as input, representations of a first probability distribution (P₁(X)) and a second probability distribution (P₂(X)) of a same random variable (X), and to return, as output, a representation of the produced probability distribution (P(X)) of said random variable (X), and
a stochastic proportional normalizer (SPN) able to receive, as input, a representation in bit form of a probability distribution, and to return, as output, a proportionally normalized representation of the received probability distribution, the proportionally normalized representation comprising more bits at 1 than the representation received as input,
a representation of a probability distribution on a random variable being a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank,
the stochastic bit vectors being sample-values, a sample-value comprising only one bit at 1,
each stochastic variable module (SV) comprising a stochastic sampler (SPS) able to be activated and deactivated, a stochastic sampler (SPS) being able to assume, as input, sample-vectors representing a probability distribution, and to return, as output, sample-values representing the same probability distribution,
each stochastic variable module (SV) being suitable for operating according to a regime, called deterministic regime, in which the stochastic variable module (SV) is able to deliver a representation of a fixed value of the random variable, and
the machine (10) comprising as many stochastic variable modules (SV) as there are random variables on which the calculation is to be done;
activating or deactivating a stochastic sampler (SPS) of at least one stochastic variable module (SV) based on the probability calculation to be done;
configuring a stochastic variable module (SV) so that the stochastic variable module (SV) operates according to the deterministic regime, and
connecting or disconnecting data buses between certain stochastic variable modules (SV) and certain stochastic distribution modules (SD) based on the probability calculation to be done.

11. The machine according to claim 2, wherein the representation of the probability distribution returned at the output of the stochastic distribution module is generated from joint or conditional probability values stored in the stochastic distribution module.

12. The machine according to claim 3, wherein the representation of the probability distribution returned at the output of the stochastic distribution module is generated from joint or conditional probability values stored in the stochastic distribution module.

13. The machine according to claim 2, wherein a representation of a probability distribution on a random variable is a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank.

14. The machine according to claim 3, wherein a representation of a probability distribution on a random variable is a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank.

15. The machine according to claim 4, wherein a representation of a probability distribution on a random variable is a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank.

16. The machine (10) according to claim 6, wherein each stochastic variable module (SV) comprises a stochastic sampler (SPS) able to be activated and deactivated, a stochastic sampler (SPS) being able to assume, as input, sample-vectors representing a probability distribution, and to return, as output, sample-values representing the same probability distribution.

17. The machine according to claim 16, wherein each stochastic variable module is suitable for operating according to a regime, called deterministic regime, in which the stochastic variable module (SV) is able to deliver a representation of a fixed value of the random variable.

18. The machine according to claim 16, wherein each stochastic variable module is connected to the stochastic distribution module by a data bus, each data bus comprising as many wires as the cardinal of the random variable corresponding to the stochastic variable module.

19. The machine according to claim 1, wherein each stochastic variable module is connected to the stochastic distribution module by a data bus, each data bus comprising as many wires as the cardinal of the random variable corresponding to the stochastic variable module.

20. A probability calculation method to be carried out on at least two random variables, the method comprising the steps of:
providing a modular stochastic machine (10) comprising:
at least one stochastic distribution module (SD) corresponding to a plurality of random variables (O, D, Z), the stochastic distribution module (SD) being able to receive an input of values of specified random variables from among the plurality of random variables, and to return as output, a representation of the distribution of probabilities of at least one non-specified random variable conditioned by the values of specified random variables received as input, and
at least two stochastic variable modules (SV), each stochastic variable module (SV) corresponding to a single random variable (O, D, Z) and comprising:
a stochastic multiplier (SPO) able to receive, as input, representations of a first probability distribution (P₁(X)) and a second probability distribution (P₂(X)) of a same random variable (X), and to return, as output, a representation of the produced probability distribution (P(X)) of said random variable (X), and
a stochastic proportional normalizer (SPN) able to receive, as input, a representation in bit form of a probability distribution, and to return, as output, a proportionally normalized representation of the received probability distribution, the proportionally normalized representation comprising more bits at 1 than the representation received as input,
a representation of a probability distribution on a random variable being a temporal series of stochastic bit vectors called sample-vectors, each sample-vector comprising as many coordinates as the cardinal of the random variable, the number of bits at 1 in the temporal series for the coordinates of a same rank being proportional to the probability value corresponding to said rank,
the stochastic bit vectors being sample-values, a sample-value comprising only one bit at 1,
each stochastic variable module (SV) comprising a stochastic sampler (SPS) able to be activated and deactivated, a stochastic sampler (SPS) being able to assume, as input, sample-vectors representing a probability distribution, and to return, as output, sample-values representing the same probability distribution,
each stochastic variable module (SV) being suitable for operating according to a regime, called deterministic regime, in which the stochastic variable module (SV) is able to deliver a representation of a fixed value of the random variable, and
the machine (10) comprising as many stochastic variable modules (SV) as there are random variables on which the calculation is to be done;
activating or deactivating a stochastic sampler (SPS) of at least one stochastic variable module (SV) based on the probability calculation to be done; and
connecting or disconnecting data buses between certain stochastic variable modules (SV) and certain stochastic distribution modules (SD) based on the probability calculation to be done.
